(19) United States
(12) Patent Application Publication
(10) Pub. No.: US 2022/0145437 A1
(43) Pub. Date: May 12, 2022

(54) SINTERED SLIDING MEMBER AND METHOD FOR PRODUCING SAME

(71) Applicant: Diamet Corporation, Niigata-shi (JP)

(72) Inventors: Ryosuke FUKUDA, Niigata-shi (JP); Yohei TAKAFUJI, Niigata-shi (JP)

(73) Assignee: Diamet Corporation, Niigata-shi (JP)

(21) Appl. No.: 17/434,176

(22) PCT Filed: Apr. 24, 2020
(86) PCT No.: PCT/JP2020/017634

§ 371 Date: Aug. 26, 2021

(30) Foreign Application Priority Data
Apr. 24, 2019 (JP) 2019-083259
Apr. 23, 2020 (JP) 2020-076829

(51) Int. Cl. C22C 38/54; C22C 38/44; C22C 38/00; C22C 38/02; B22F 3/10; F16C 33/58

(52) U.S. Cl. CPC C22C 38/54; C22C 38/44; C22C 38/002; F16C 2220/20; B22F 3/10; F16C 33/58; F16C 2204/72; C22C 38/02

(57) ABSTRACT

A heat-resistant sintered sliding member according to the present invention has a structure in which a lubrication phase is dispersed in a matrix, in which an entire composition of the sliding member is composed of a composition containing, by mass %, Cr: 18% to 35%, Mo: 0.3% to 15%, Ni: 0% to 30%, Si: 0.5% to 6%, S: 0.2% to 4.0%, P: 0% to 1.2%, B: 0% to 0.8%, and a Fe balance containing inevitable impurities, in which the matrix is a Fe—Cr—Mo—Si-based matrix or a Fe—Cr—Mo—Ni—Si-based matrix, the lubrication phase contains chromium sulfide, and a porosity of an entire sliding member is 2.0% or less.

### CROSS-REFERENCE TO RELATED PATENT APPLICATIONS

This application is a U.S. National Phase application under 35 U.S.C. § 371 of International Patent Application No. PCT/JP2020/017634 filed on Apr. 24, 2020, which claims the benefit of priority to Japanese Applications No. 2019-083259 filed on Apr. 24, 2019 and No. 2020-076829 filed on Apr. 23, 2020, the contents of all of which are incorporated herein by reference in their entireties. The International Application was published in Japanese on Oct. 29, 2020 as International Publication No. WO/2020/218479 under PCT Article 21(2).

### FIELD OF THE INVENTION

The present invention relates to a solid lubricant-dispersed sintered sliding member having low mating attacking properties in sliding wear and having heat resistance, and a method for producing the same.

### BACKGROUND OF THE INVENTION

An exhaust gas recirculation system (EGR) which returns some of an exhaust gas to an intake side in an internal combustion engine to adjust a combustion temperature of the engine is known. Since a bearing or a bush for a valve shaft part used in this EGR is used near the exhaust gas discharged from the engine, it is desired that it is a movable component and is excellent even in a viewpoint of sliding properties, while being constantly exposed to a high-temperature and corrosive exhaust gas.

As such a kind of the sliding component exposed to the high-temperature and corrosive exhaust gas, a Co-based wear-resistant sintered parts obtained by adding Mo, Cr, Si, or the like to Co is known in the related art (see Japanese Patent No. 4582587).

This wear-resistant sintered part is a Co-based hard particle added material obtained by mixing a base-forming powder and a hard phase-forming powder, and compacting and sintering it, in which the base-forming powder is a fine powder having a maximum grain size of stainless steel of 46 μm, the hard phase-forming powder is composed of a composition containing, by a mass ratio, Mo: 20% to 60%, Cr: 3% to 12%, Si: 1% to 12%, and a balance of Co, and a ratio of the hard phase-forming powder to the base-forming powder is 40% to 70%.

In addition, in the related art, as a wear-resistant sintered alloy used for a heavy-duty diesel engine and the like, a wear-resistant sintered alloy in which particles of molybdenum silicide are dispersed in a Co alloy base composed of a composition containing, by a mass ratio, Mo: 20% to 40%, Cr: 7% to 9%, Si: 2% to 3%, and a balance of Co is known (see Japanese Unexamined Patent Application, First Publication No. 2007-238987).

The sintered alloy disclosed in Japanese Unexamined Patent Application, First Publication No. 2007-238987 has a structure in which a Cr sulfide is dispersed around a hard phase, by dispersing 5% to 40% of a hard phase in which precipitates mainly composed of molybdenum silicate are integrally precipitated in a group shape, and a lubrication phase in which chromium sulfide particles are precipitated in a group shape in a Fe—Cr-based alloy base.

### CITATION LIST

### Patent Documents

[Patent Document 1]
Japanese Patent No. 4582587
[Patent Document 2]
Japanese Unexamined Patent Application, First Publication No. 2007-238987

### Technical Problem

A bearing applied to an exhaust valve or the like in a high temperature environment in such as the EGR described above employs a structure in which hard particles are dispersed in a base in order to improve wear resistance in the technology of the related art, but in a case where a hardness of a shaft is low, there is a problem that the shaft wears.

In order to suppress the wear of the shaft, it is necessary to apply a hard material to the shaft, which has a problem of increasing a cost of an EGR unit.

In addition, a wear-resistant material used for a valve seat includes a large number of pores and has a problem that it cannot be used in a high temperature range.

Against the above background, the inventors of the present invention have conducted intensive studies regarding wear resistance of a sintered part, and found that, by providing a metal structure in which chromium sulfide, which is a lubrication phase is dispersed in a matrix of a Fe—Cr based alloy having excellent corrosion resistance, excellent wear resistance can be exhibited and attacking properties to a mating material can be reduced, and the present invention has been reached.

The present invention has been made in view of the circumstances as described above, and an objective thereof is to provide a sintered sliding member having a low porosity, oxidation resistance, excellent wear resistance, and low mating attacking properties, and a method for producing the same.

### SUMMARY OF THE INVENTION

### Solution to Problem

(1) In order to solve the aforementioned problems, according to an aspect, there is provided a sintered sliding member that has a structure in which a lubrication phase is dispersed in a matrix, in which an entire composition of the sliding member is composed of a composition containing, by mass %, Cr: 18% to 35%, Mo: 0.3% to 15%, Ni: 0% to 30%, Si: 0.5% to 6%, S: 0.2% to 4.0%, P: 0% to 1.2%, B: 0% to 0.8%, and a Fe balance containing inevitable impurities, the matrix is a Fe—Cr—Mo—Si-based matrix or a Fe—Cr—Mo—Ni—Si-based matrix, the lubrication phase contains Cr sulfide, and a porosity of an entire sliding member is 2.0% or less.

In a case of a structure in which the lubrication phase containing the chromium sulfide is dispersed in the Fe—Cr—Mo—Si-based matrix or in the Fe—Cr—Mo—Ni—Si-based matrix, the chromium sulfide, which is the lubrication phase, is dispersed in the matrix set to have a composition having excellent corrosion resistance by containing Si in a composition having high strength by adding Cr and Mo to Fe, thereby adjusting the mating attacking properties by a dispersion amount thereof. In addition, by using a sintering aid such as Fe—P and Fe—B or controlling sintering conditions, a dense sintered sliding member having a low porosity can be obtained. Therefore, there is little possibility that corrosion proceeds to the inside, although the sintered sliding member is exposed to a corrosive liquid or gas. Accordingly, it is possible to obtain a sintered sliding member having excellent corrosion resistance and heat resistance.

Therefore, it is possible to provide a sintered sliding member capable of obtaining excellent wear resistance, oxidation resistance, and heat resistance, while maintaining excellent oxidation resistance.

(2) In the present aspect, it is preferable that the lubrication phase is formed of Cr—S or (Cr—Mo—Fe)—S.

(3) In order to solve the aforementioned problems, according to another aspect, there is provided a sintered sliding member that has a structure in which a lubrication phase and a solid lubricant are dispersed in a matrix, in which a composition of a main phase formed of the matrix and the lubrication phase is composed of a composition containing, by mass %, Cr: 18% to 35%, Mo: 0.3% to 15%, Ni: 0% to 30%, Si: 0.5% to 6%, S: 0.2% to 4.0%, P: 0% to 1.2%, B: 0% to 0.8%, and a Fe balance containing inevitable impurities, the matrix is a Fe—Cr—Mo—Si-based matrix or a Fe—Cr—Mo—Ni—Si-based matrix, the lubrication phase contains chromium sulfide, a porosity of an entire sliding member is 2.0% or less, the solid lubricant is composed of one or two or more of CaF₂, talc, and BN, and the solid lubricant is contained in an amount of 1 mass % or less with respect to the main phase.

(4) There is provided a production method of the present aspect that has a structure in which a lubrication phase is dispersed in a matrix, in which an entire composition of the sliding member is composed of a composition containing, by mass %, Cr: 18% to 35%, Mo: 0.3% to 15%, Ni: 0% to 30%, Si: 0.5% to 6%, S: 0.2% to 4.0%, P: 0% to 1.2%, B: 0% to 0.8%, and a Fe balance containing inevitable impurities, the matrix is a Fe—Cr—Mo—Si-based matrix or a Fe—Cr—Mo—Ni—Si-based matrix, the lubrication phase contains chromium sulfide, and a porosity of an entire sliding member is 2.0% or less, the method including the steps of: mixing a FeCr-based or FeCrNi-based alloy powder with a MoS₂ powder to obtain a mixed powder; press-forming the mixed powder to produce a green compact; and sintering the green compact at 1100° C. or higher in a vacuum atmosphere.

(5) There is provided a production method of the present aspect that has a structure in which a lubrication phase and a solid lubricant are dispersed in a matrix, in which a composition of a main phase formed of the matrix and the lubrication phase is composed of a composition containing, by mass %, Cr: 18% to 35%, Mo: 0.3% to 15%, Ni: 0% to 30%, Si: 0.5% to 6%, S: 0.2% to 4.0%, P: 0% to 1.2%, B: 0% to 0.8%, and a Fe balance containing inevitable impurities, the matrix is a Fe—Cr—Mo—Si-based matrix or a Fe—Cr—Mo—Ni—Si-based matrix, the lubrication phase contains chromium sulfide, a porosity of an entire sliding member is 2.0% or less, the solid lubricant is composed of one or two or more of CaF₂, talc, and BN, and the solid lubricant is contained in an amount of 1 mass % or less with respect to the entire composition including the matrix, the lubrication phase, and the solid lubricant, the method including the steps of: mixing a FeCr-based or FeCrNi-based alloy powder, a MoS₂ powder, and a solid lubricant powder with each other to obtain a mixed powder; press-forming the mixed powder to produce a green compact; and sintering the green compact at 1100° C. or higher in a vacuum atmosphere.

In the production method of the present aspect, in a case of producing the mixed powder, at least one kind of a FeCr alloy powder, a FeSi alloy powder, a CrSi alloy powder, a FeMo alloy powder, and a FeS₂ powder may be added and mixed.

When preparing a raw material powder, if at least one kind of an additive powder such as a FeCr alloy powder, a FeSi alloy powder, a CrSi alloy powder, a FeMo alloy powder, a FeS₂ powder, and the like is mixed with a base powder such as a Fe—Cr—Mo—Si alloy powder or a Fe—Cr—Mo—Ni—Si alloy powder to obtain a mixed powder, a raw material powder can be prepared while suppressing the amounts of Si, Mo, and Cr contained in the base powder. Si or Cr contained in any of the additive powders can be diffused at the time of sintering to increase a Si content and a Cr content on the matrix side.

If the base powder contains Si or Cr having a desired high concentration from the beginning, the base powder becomes too hard. Accordingly, it is difficult to increase density, when the raw material powder is pressed to obtain a green compact and it is difficult to obtain a sintered material having a low porosity.

Therefore, by using the raw material mixed powder described above, a strength and corrosion resistance of the matrix after the sintering can be increased, and it is possible to produce a sintered sliding member having excellent wear resistance and low mating attacking properties along with precipitation of the lubrication phase.

(6) In the production method of the present invention, at least one of a FeP powder and a FeB powder may be added and mixed with the mixed powder.

By adding these powders to the mixed powder, these powders become a liquid phase at the time of sintering to exhibit an effect of accelerating the sintering, and it is possible to obtain a dense sintered sliding member having a small number of pores.

### Advantageous Effects of Invention

In the present invention, a structure in which a specific amount of Fe, Cr, Mo, Ni, Si, and S is contained in the entire composition and the lubrication phase is dispersed in the matrix phase containing Fe, Cr, Mo, and Si is provided, and the amount of Si contained in the matrix having a high strength is increased. Accordingly, it is possible to increase corrosion resistance of the matrix, have excellent wear resistance by the dispersion of the chromium sulfide, and adjust even wear properties of a mating material by a dispersion amount thereof. In addition, by decreasing the porosity and forming a dense structure, a dense sintered sliding member can be obtained. Therefore, there is little possibility that corrosion proceeds to the inside, although the sintered sliding member is exposed to a corrosive liquid or gas. Accordingly, it is possible to obtain a sintered sliding member having excellent oxidation resistance and wear resistance.

Therefore, the sintered sliding member of the present application can be effectively applied to a mechanical component such as a bearing or a bush incorporated in an engine including an exhaust gas recirculation system, and a mechanical component that is a movable component and is excellent even in a viewpoint of sliding properties, while being constantly exposed to a high-temperature and corrosive exhaust gas discharged from the engine.

In addition, in the sintered sliding member of the present application, the it is possible to improve the sliding properties by adding a predetermined amount of one or two or more of CaF₂, talc, and BN.

### BRIEF DESCRIPTION OF THE DRAWINGS

FIG. 1 is a perspective view showing an example of a bearing part formed by a sintered sliding member according to the present invention.

FIG. 2 is a microstructure photograph showing an example of a metal structure of a specimen produced in examples.

### DETAILED DESCRIPTION OF THE INVENTION

Hereinafter, an embodiment of the present invention will be described with reference to the drawings.

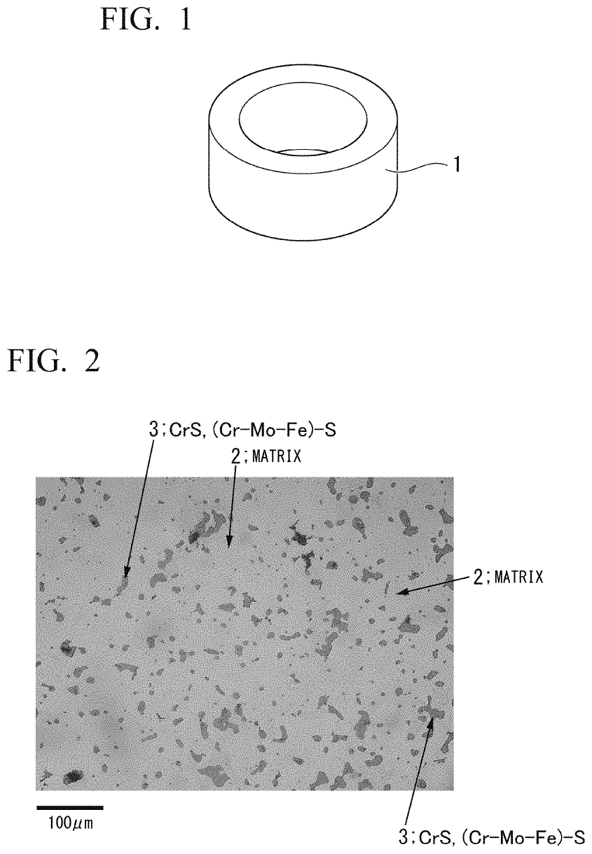

FIG. 1 shows a cylindrical bearing part 1 formed of a sintered sliding member according to the present invention, and the bearing part 1 is used as an example for a bearing incorporated in a nozzle mechanism or a valve mechanism for a turbocharger. FIG. 2 is an enlarged microstructure photograph of the sintered sliding member configuring the bearing part obtained in examples which will be described later.

As an example, as shown in FIG. 2, the sintered sliding member has a structure in which a plurality of lubrication phases “CrS, (Cr—Mo—Fe)—S” 3 in an undefined shape formed of chromium sulfide are dispersed in a Fe-based alloy matrix 2 containing Cr, Mo, Si, and S. The alloy matrix 2 may be a Fe-based alloy matrix containing Cr, Mo, Ni, Si, and S, and the alloy matrix of these compositions may further contain at least one of P and B.

In addition, a plurality of holes (pores) may be dotted over the entire structure shown in FIG. 2. In the sintered sliding member of the present embodiment, a porosity is desirably 2.0% or less in the entire structure.

As an example, the sintered sliding member of the present embodiment has a composition composed containing, by mass %, Cr: 18% to 35%, Mo: 0.3% to 15%, Ni: 0% to 30%, Si: 0.5% to 6.0%, S: 0.2% to 4.0%, P: 0% to 1.2%, B: 0% to 0.8%, and a Fe balance containing inevitable impurities in the entire composition. As an example, the lubrication phase 3 is preferably formed of chromium sulfide ((Cr—Mo—Fe)—S containing Cr—S as a main component), Cr—S, or (Cr—Mo—Fe)—S.

The matrix 2 containing Cr, Mo, Ni, and Si is, for example, formed of a Fe—Cr—Mo—Si-based matrix or a Fe—Cr—Mo—Ni—Si-based matrix.

The composition of the matrix 2 and the lubrication phase 3 is determined as the composition described above from a micrograph showing a structure of an example specimen and a result of EDX analysis (energy dispersive X-ray spectrometry) which will be described later.

Hereinafter, reasons for limiting each composition ratio of the sintered sliding member of the present embodiment will be described.

In the following description, % indicating a content of an element means mass %, unless otherwise specified.

“Cr Content: 18% to 35%”

It is necessary that a Cr content contains in an amount of at least 18% or greater, from a viewpoint of heat resistance. If the Cr content is less than 18%, a passivation film of Cr is reduced, and the heat resistance of the sintered sliding member is decreased. If the Cr content exceeds 35%, an 6 phase is generated in the sintered material and the sintered sliding member becomes a brittle material, which is not preferable.

In this specification, when an upper limit and a lower limit of a content range of a specific element are specified by using “to”, the range includes the upper limit and the lower limit, unless otherwise specified. Therefore, 18% to 35% means 18% or greater and 35% or less. Although not particularly limited, even if the Cr content is within the range described above, a range of 18% to 25% can be selected, and a range of 19% to 24% can be selected.

“S Content: 0.2% to 4.0%”

S reacts with Cr in the sintered sliding member of the present embodiment to generate chromium sulfide (Cr—S). Accordingly, it affects mating attacking properties. If the S content is less than 0.2%, the mating attacking properties are increased and this leads to a deterioration in wear resistance. For example, a shaft, which is a mating material of the bearing, is easily worn. In addition, if the S content exceeds 4.0%, a dispersion amount of the solid lubrication phase becomes too large, and this leads to a decrease in strength of the sintered sliding member. Although not particularly limited, even if the S content is within the range described above, a range of 1.0% to 4.0% can be selected.

“Si Content: 0.5% to 6%”

A Si content affects the oxidation resistance in the sintered sliding member of the present embodiment, and it is necessary that the Si content is 0.5% or greater, in order to improve the oxidation resistance. If the Si content is less than 0.5%, the oxidation resistance decreases. If the Si content exceeds 6%, an amount of a liquid phase generated during the sintering becomes too large, and as a result, a deformation during the sintering increases. Accordingly, the Si content is set to 6% or less. Although not particularly limited, even if the Si content is within the range described above, a range of 0.5% to 1.2% can be selected.

“Mo Content: 0.3% to 15%”

Mo contributes to the improvement of corrosion resistance and heat resistance in the sintered sliding member of the present embodiment. By containing 0.3% or greater of Mo, it contributes to the improvement of corrosion resistance and heat resistance. Since Mo is an expensive element, it is desirable that the Mo content is small, in terms of cost. If the Mo content is greater than 15%, an 6 phase is generated and the strength is decreased, which is not preferable. Although not particularly limited, even if the Mo content is within the range described above, a range of 2% to 6% can be selected, and a range of 2% to 5% can be selected.

“Ni Content: 0% to 30%”

If a Ni content is small in the sintered sliding member of the present embodiment, there is no particular problem, because the matrix 2 is ferrite-based. Even if the Ni content exceeds 30%, it does not contribute much to austenitization, and there is no particular negative effect by containing a large amount of Ni. However, it is difficult to ensure an amount of other necessary elements and moldability is reduced. Accordingly, it is preferably 30% or less. Although not particularly limited, even if the Ni content is within the range described above, a range of 0% to 20% can be selected, and a range of 14% to 20% can be selected.

“P Content: 0% to 1.2%”

A P content affects sinterability or density of the sintered sliding member of the present embodiment. If the P content exceeds 1.2%, an amount of a liquid phase becomes too large during the sintering, and a deformation during the sintering increases. Accordingly, the P content is preferably 1.2% or less. Although not particularly limited, even if the P content is within the range described above, a range of 0.5% to 1.2% can be selected.

“B Content: 0% to 0.8%”

A B content affects the sinterability or density of the sintered sliding member of the present embodiment. If the B content exceeds 0.8%, an amount of a liquid phase becomes too large during the sintering, and a deformation during the sintering increases. Accordingly, the B content is preferably 0.8% or less. Although not particularly limited, even if the B content is within the range described above, a range of 0.09% to 0.8% can be selected for the B content when adding B.

P and B are elements that may not be positively added to the sintered sliding member of the present embodiment, but when they are added, it is preferable to select the ranges described above for the reasons described above.

“Porosity: 2.0% or Less”

In the sintered sliding member of the present embodiment, if the porosity is great, a surface area increases and the sintered sliding member is easily oxidized. Accordingly, in a case where the porosity is small, the oxidation resistance of the sintered sliding member can be improved. Therefore, it is desirable that the porosity is 2.0% or less. By suppressing the porosity to 2.0% or less, the density of the sintered sliding member can be increased. Accordingly, it can be applied to a part with a high-temperature around an exhaust valve in a mechanical component around the engine. Although not particularly limited, even in the range described above, a range of 0% to 1.8% can be selected for the porosity.

In the sintered sliding member of the present embodiment, approximately 5 to 30 volume % of the lubrication phase 3 formed of chromium sulfide ((Cr—Mo—Fe)—S containing Cr—S as a main component, Cr—S, or (Cr—Mo—Fe)—S) is dispersed in the matrix 2.

Regarding the chromium sulfide constituting the lubrication phase 3, a MoS₂ powder added into a raw material mixed powder that is a basis for producing the sintered sliding member is thermally decomposed at a high-temperature during the sintering, Mo is diffused into the matrix 2, most of S reacts with Cr existing in the matrix to form CrS, which is precipitated and dispersed in the matrix in a particulate form.

Since approximately 5 to 30 volume % of the lubrication phase 3 of the chromium sulfide is dispersed in the matrix 2, it is possible to suitably suppress the wear of the mating material which slides the sintered sliding member of the present embodiment. If a ratio of the lubrication phase 3 is less than 5 volume %, the amount of the lubrication phase 3 is insufficient. Accordingly, the wear of the mating material increases. If the ratio of the lubrication phase 3 exceeds 30 volume %, the strength is insufficient. Although not particularly limited, even in the range described above, a range of 5% to 29% can be selected and a range of 10% to 18% can be selected for the volume ratio of the lubrication phase.

In addition, as another example, the sintered sliding member of the present embodiment may have a structure in which a lubrication phase and a solid lubricant are dispersed in a matrix, in which a composition of a main phase formed of the matrix and the lubrication phase is composed of a composition containing, by mass %, Cr: 18% to 35%, Mo: 0.3% to 15%, Ni: 0% to 30%, Si: 0.5% to 6%, S: 0.2% to 4.0%, P: 0% to 1.2%, B: 0% to 0.8%, and a Fe balance containing inevitable impurities, in which the matrix is a Fe—Cr—Mo—Si-based matrix or a Fe—Cr—Mo—Ni—Si-based matrix, the lubrication phase contains chromium sulfide, a porosity of an entire sliding member is 2.0% or less, the solid lubricant is composed of one or two or more of CaF₂, talc, and BN, and the solid lubricant is contained in an amount of 1 mass % or less with respect to the main phase.

In the sintered sliding member of the present embodiment, the contents of Cr, Mo, Ni, Si, S, P, and B are the same as those of the sintered sliding member according to the previous embodiment. The configuration of the matrix phase and the configuration of the lubrication phase are the same, but the present embodiment is different in that the solid lubricant is contained.

The solid lubricant is composed of one or two or more of CaF₂, talc, and BN, and is dispersed in particulate form in a structure separately from the matrix and the lubrication phase.

In a case where the solid lubricant is contained, some of the constituent elements of the solid lubricant may be partially diffused into the matrix, and the constituent elements of the solid lubricant may be contained in the matrix. However, there is no particular effect to the properties of the matrix.

The solid lubricant can be added in a range of 1 mass % or less with respect to a main phase composed of the matrix and the lubrication phase. If the added amount of the solid lubricant is less than 1 mass %, it is possible to improve sliding properties of the sintered sliding member without negatively affecting the properties of the main phase.

If the added amount of the solid lubricant to the main phase exceeds 1 mass %, the number of pores increases and the density of the sintered sliding member decreases, which is not desirable.

“Production Method”

A method for producing the sintered sliding member according to the present embodiment will be described later in detail, but as an example, in addition to the Fe—Cr—Mo—Si alloy powder or the Fe—Cr—Mo—Ni—Si alloy powder as the base powder and the MoS₂ powder for forming the lubrication phase, the additive powders (at least one kind of a FeCr alloy powder, a FeSi alloy powder, a CrSi alloy powder, a FeMo alloy powder, and FeS₂ powder, a FeB powder, or a FeP powder) are weighed so as to have the composition ranges described above, a mixed powder obtained by uniformly mixing is press-molded at a pressure of approximately 490 to 980 MPa, and the obtained pressed molded body is sintered at 1100° C. to 1300° C. and more preferably 1200° C. to 1280° C. for approximately 0.5 to 2 hours in vacuum or a nitrogen atmosphere.

As the base powder, a Fe—Cr—Si alloy powder may be used instead of the Fe—Cr—Mo—Si alloy powder.

In addition, in a case of adding the solid lubricant to the sintered sliding member, a necessary amount of one or two or more of a CaF₂ powder, a talc powder, and a BN powder can be added to obtain a mixed powder at the stage of mixing the powders as described above.

Specifically, as an applicable base powder, a stainless alloy powder containing 13% or greater of Cr with respect to Fe and defined as an alloy having rust resistance can be used.

For example, powders of stainless alloys such as JIS specified SUS310S alloy, SUS316 alloy, and SUS430 alloy can be used.

The SUS310S alloy is a FeCrNi-based alloy containing 19% to 22% of Ni and 24% to 26% of Cr, and the SUS316 alloy is a FeCrNiMo-based alloy containing 10% to 14% of Ni, 16% to 18% of Cr, and 2% to 3% of Mo, and the SUS430 alloy is a FeCr-based alloy containing 16% to 18% of Cr.

In addition, the FeB powder or the FeP powder can be used as the sintering aid, but these sintering aids may be omitted.

As the additive powder, a FeSi powder, a CrSi powder, a FeCr alloy powder, a FeMo alloy powder, and the like may be mixed with the base powder so as to have the composition range described above.

When each of the powders described above is used, a particle size (D50) of each powder is preferably approximately 5 to 100 μm.

When the FeB powder is used as the sintering aid, the added amount of B to the entire part is desirably in a range of 0 to 0.8% as described above.

When the FeP powder is used as the sintering aid, the added amount of P to the entire part is preferably 0 to 1.2% as described above.

As the sintering aid, FeP may be used in addition to FeB, or a mixture thereof may be used. When the particle size of the powder to be used is adjusted to 5 to 20 μm to form a fine powder, these sintering aids may be omitted.

When producing the raw material mixed powder, in a case of using a powder having a particle size of approximately 30 to 100 μm as the raw material powder, if the sintering aid is added and sintered, it is possible to produce a desired heat-resistant sintered sliding member having a low porosity. In a case where the sintering aid is not used, if the particle size of the raw material powder is set to approximately 5 to 20 μm to obtain a fine powder, it is possible to produce a desired heat-resistant sintered sliding member having a low porosity.

As the raw material powder, a powder having a particle size (D50) of 10 μm can be sufficiently produced, but if the particle size is too small, the powder may flow to clearance of a metal die during metal die press-molding, and galling occurs on the metal die. In a case of fine powder, for example, a powder having a particle size of 5 to 20 μm can be used, and in a case of a raw material powder having a particle size greater than this range, it is necessary to add a sintering aid. As an example, a fine powder having an average particle size (D50) of approximately 10 μm can be used.

Since the base powder has a large amount of Cr and is easily oxidized, Si is required to suppress the amount of oxygen. The Si content can be slightly lower than 1%, but approximately 0.5% to 0.8% thereof is contained, in order to suppress the amount of oxygen. Accordingly, it is desirable that the base powder contains Si slightly less than 1%. In order to increase the Si content in the matrix 2, it can be adjusted by adding the necessary amount of FeSi or CrSi powder as a Si source.

The mixed powder is put into a mold of a press device and press-molded to obtain a green compact having a desired shape, for example, a tubular shape.

In a case of the molding, various methods such as hot hydrostatic pressure pressurization (HIP) and cold hydrostatic pressure pressurization (CIP) may be used, in addition to the molding by a press device.

By sintering this green compact at a predetermined temperature in a range of 1100° C. to 1280° C. for about 0.5 to 2 hours in a vacuum atmosphere or a nitrogen atmosphere, for example, it is possible to obtain the tubular bearing part 1 shown in FIG. 1, for example, formed of a sintered sliding member in which the lubrication phase of chromium sulfide is dispersed in the Fe—Cr—Mo—Si-based matrix or the Fe—Cr—Mo—Ni—Si-based matrix, can be obtained.

As shown in FIG. 2, the heat-resistant sintered sliding member constituting the bearing part 1, for example, has a metal structure in which the lubrication phase 3 of chromium sulfide is dispersed in the Fe—Cr—Mo—Si-based or Fe—Cr—Mo—Ni—Si-based matrix 2. FIG. 2 is a photograph of an example of a heat-resistant sintered sliding member specimen produced in the examples which will be described later, in which a part of the structure is magnified by an optical microscope.

As shown in FIG. 2, some pores (approximately 2.0% or less) generated during the sintering may remain in the metal structure of the heat-resistant sintered sliding member 1. In FIG. 2, some black spots correspond to the pores.

In a case where a FeCrMoSi alloy powder or a FeCrMoNiSi alloy powder, the FeB powder or the FeP powder, and the MoS₂ powder are mixed, press-molded, and then sintered, FeB or FeP becomes a liquid phase and spread wet to a boundary with other powder particles to fill the pores. Accordingly, the grain boundaries of the FeCrMoSi alloy powder or the FeCrMoNiSi alloy powder and other powders can be filled with FeB or FeP which is a liquid phase. As a result, the porosity after the sintering can be decreased to 2.0% or less. Therefore, a high-density sintered sliding member can be obtained.

As is clear from a FeB dual phase diagram, Fe and B constituting the FeB powder have a eutectic point at 1174° C. with a composition of Fe-4% B. Accordingly, the liquid phase is eutecticized at the sintering temperature, and this liquid phase acts as the sintering aid to improve a sintering density. Therefore, it is possible to obtain a sintered material having a high density after the sintering with a small number of pores generated, that is, a dense sintered material having a low porosity. Since the porosity is low, corrosive liquids and gas is difficult to enter the inside of the sintered material from the outside, and this contributes to the improvement of oxidation resistance.

When performing the sintering at the temperature described above, Fe, Cr, Mo, Si, and Ni existing around the FeCrMoSi alloy powder or the FeCrMoNiSi alloy powder are mutually diffused to form a matrix. Meanwhile, MoS₂ is thermally decomposed at the time of the sintering, and Mo is diffused in the matrix, but most of S reacts with Cr to be dispersed in the matrix as chromium sulfide in a particulate form.

That is, the structure in which the lubrication phase 3 mainly composed of particulate chromium sulfide is dispersed between the Fe—Cr—Mo—Si matrix or between the Fe—Cr—Mo—Ni—Si matrix phase. By dispersing these lubrication phases 3, it is possible to decrease the mating attacking properties and obtain excellent wear resistance.

The Fe—Cr—Mo—Si alloy powder or Fe—Cr—Mo—Ni—Si alloy powder used as the base powder contains Si, but if more than 1% of Si is added to this base powder, it becomes too hard and the compression is difficult during the press-molding. Accordingly, the Si content added to the base powder is preferably 1.0% or less.

It is possible to ensure the oxidation resistance by the Fe—Cr—Mo—Si-based or Fe—Cr—Mo—Ni—Si-based matrix 2 obtained by containing Cr, Mo, and Si in the Fe base.

In the present embodiment, the ring-shaped bearing part 1 is configured by using the heat-resistant sintered sliding member described above, but the heat-resistant sintered sliding member of the present embodiment can be widely applied to a shaft member or a rod member, a bearing part, a plate, and the like provided in a nozzle mechanism or a valve mechanism of a turbocharger.

In the sintered sliding member obtained by the production method described above, since the matrix phase contains a sufficient amount of Cr, excellent oxidation resistance is exhibited, and the lubrication phase 3 is formed of chromium sulfide having excellent lubricity by the matrix, thereby alleviating attacking properties to a mating material. Since the matrix having excellent oxidation resistance and the heat resistance with high strength by containing a suitable amount of Cr in Fe or containing a suitable amount of Cr and Ni in Fe, is obtained, excellent wear resistance is obtained, in addition to excellent oxidation resistance and heat resistance. Therefore, the bearing part 1 described above has excellent oxidation resistance, excellent heat resistance, and excellent wear resistance, even when it is applied to a bearing portion of a turbocharger or the like and is slid by a shaft while being exposed to high-temperature exhaust gas.

In addition, in a case where the sintered sliding member contains the solid lubricant, if 1 mass % or less thereof is added, the sliding properties can be improved.

The heat-resistant sintered sliding member of the present embodiment can be used as a constituent material of the turbocharger shaft, and can also be applied as a constituent material of various mechanical components provided in an environment exposed to high-temperature corrosive gas in terms of oxidation resistance and wear resistance.

### Examples

Hereinafter, the present invention will be described more specifically with reference to examples, but the present invention is not limited to these examples.

As the raw material powder, any one of JIS-specified SUS310 alloy powder (particle size D50=100 μm), SUS316 alloy powder (particle size D50=100 μm), and SUS430 alloy powder (particle size D50=100 μm) was used as the base powder.

A FeP powder (sintering aid: D50=30 μm) and any of the following powders were added to the base powder. In addition to MoS₂ powder (D50=4 μm), the added powders are FeCr alloy powder (particle size D50=50 μm), FeSi alloy powder (particle size D50=50 μm), and the FeS₂ alloy powder (particle size D50=100 μm) were added as necessary, to prepare the raw material mixed powder by mixing to have the composition of each example shown in Table 1 (Examples 1 to 11 and Comparative Examples 1 to 11) by a V-type mixer for 30 minutes.

Next, the FeP powder as the sintering aid was changed to FeB powder so as in the composition shown in Table 2 (Examples 12 to 14 and Comparative Example 12), and mixed by a V-type mixer for 30 minutes, to prepare the raw material mixed powder.

Next, as in the composition shown in Table 2 (Examples 15 and 16), a specimen (Example 15) in which the SUS310 alloy powder of the raw material powder was changed to a fine powder (D50=10 μm) was prepared, and a specimen (Example 16) obtained by adding both the FeP powder and the FeB powder with a SUS310 alloy powder having a normal particle size (D50=100 μm) and mixing in a V-type mixer for 30 minutes was prepared.

Next, any of a CaF₂ powder (particle size D50=30 μm), a talc powder (particle size D50=10 μm), and a BN powder (particle size D50=10 μm) was added to the specimen of Example 6 shown in Table 1, so as to have each added amount (Examples 17 to 22 and Comparative Examples 13 to 15) shown in Table 3, to prepare a specimen.

These mixed powders were press-molded at a molding pressure of 490 to 980 MPa to prepare a tubular green compact.

Next, this green compact was sintered in a vacuum atmosphere at a temperature of 1100° C. to 1300° C. for 0.5 to 2.0 hours to obtain a tubular sintered sliding member.

Each of the sintered sliding members was molded into a shape suitable for each of the following tests and subjected to each test.

“Porosity”

The porosity to the Archimedes method, JIS Z2501: 2000 sintered metal material-density, oil content and open porosity test method.

“Oxidation Resistance Test”

In the oxidation resistance test, a ring-shaped heat-resistant sintered sliding member (bearing part) having dimensions of outer diameter: 20 mm×inner diameter: 10 mm×height: 5 mm and having the compositions shown in Tables 1 and 2 was obtained and tested.

The conditions were determined by whether or not peeling occurred on the oxidation scale on the specimen surface after heating at 700° C. in the air and holding for 100 hours. The oxidation scale that is not peeled was set A, and those peeled was set as B.

“Radial Crushing Strength”

A ring-shaped heat-resistant sintered sliding member (bearing part) having dimensions of outer diameter: 20 mm×inner diameter: 10 mm×height: 5 mm and having the compositions shown in Tables 1 and 2 was prepared and tested. The conditions were measured according to the JIS Z2507 sintered bearing-radial crushing strength test method, and 400 MPa or more was determined as excellent. In each table which will be described later, it is simply described as strength.

“Wear Test”

A wear test was performed in a roll-on block test. A columnar shaft of SUS316 was placed on a block test piece and slid back and forth at 90° for 30 minutes at 600° C. in the air, and the amount of wear (μm) was evaluated after 2000 sliding times. It is determined that a specimen having a block>roll and a block≤80 μm in terms of wear amount as an excellent specimen.

The above test results are shown in Table 1, Table 2, and Table 3 below.

TABLE 1

| | | | | | | | | | Oxidation resistance | | | | | Volume |
|---|---|---|---|---|---|---|---|---|---|---|---|---|---|---|
| | | | | | | | | | | Presence or | | | | ratio of |
| | | | | | | | | | | absence of | | Wear resistance | | lubrication |
| Specimen | Total composition (mass %) | | | | | | | | Porosity | oxidation | Strength | Block | Roll | phase |
| No. | Cr | Mo | Ni | P | B | Si | S | Fe | (%) | scale peeling | (MPa) | (μm) | (μm) | (volume %) |
| Example 1 | 24.45 | 0.31 | 19.67 | 0.57 | 0.00 | 0.97 | 0.20 | Balance | 0.6 | A | 1058 | 55 | 47 | 5 |
| Example 2 | 18.30 | 14.89 | 14.73 | 0.57 | 0.00 | 0.73 | 3.94 | Balance | 0.9 | A | 432 | 32 | 4 | 29 |
| Example 3 | 22.06 | 5.89 | 17.76 | 0.57 | 0.00 | 0.88 | 3.94 | Balance | 0.3 | A | 650 | 37 | 4 | 29 |
| Example 4 | 23.32 | 2.94 | 18.77 | 0.57 | 0.00 | 0.55 | 1.97 | Balance | 1.7 | A | 779 | 67 | 14 | 14 |
| Example 5 | 21.81 | 2.94 | 17.55 | 0.57 | 0.00 | 5.67 | 1.97 | Balance | 0.2 | A | 560 | 49 | 12 | 14 |
| Example 6 | 18.11 | 4.70 | 11.16 | 0.57 | 0.00 | 0.77 | 1.97 | Balance | 0.3 | A | 1197 | 76 | 22 | 14 |
| Example 7 | 34.89 | 2.94 | 12.91 | 0.57 | 0.00 | 0.64 | 1.97 | Balance | 0.8 | A | 410 | 72 | 8 | 14 |
| Example 8 | 18.19 | 2.94 | 0.00 | 0.57 | 0.00 | 0.66 | 1.97 | Balance | 0.3 | A | 1278 | 63 | 8 | 14 |
| Example 9 | 19.80 | 2.94 | 29.94 | 0.57 | 0.00 | 0.79 | 1.97 | Balance | 0.4 | A | 1181 | 66 | 7 | 14 |
| Example 10 | 23.64 | 2.94 | 19.03 | 0.22 | 0.00 | 0.94 | 1.97 | Balance | 1.8 | A | 791 | 40 | 13 | 14 |
| Example 11 | 22.79 | 2.94 | 18.34 | 1.13 | 0.00 | 0.91 | 1.97 | Balance | 0.3 | A | 1039 | 57 | 8 | 14 |
| Comparative | 16.04 | 3.66 | 12.05 | 0.57 | 0.00 | 0.84 | 1.18 | Balance | 0.2 | B | 1228 | 92 | 26 | 10 |
| Example 1 | | | | | | | | | | | | | | |
| Comparative | 15.70 | 4.80 | 11.80 | 0.57 | 0.00 | 0.82 | 1.97 | Balance | 0.1 | B | 1132 | 66 | 8 | 14 |
| Example 2 | | | | | | | | | | | | | | |
| Comparative | 14.86 | 7.64 | 11.16 | 0.57 | 0.00 | 0.77 | 3.94 | Balance | 0.2 | B | 804 | 40 | 3 | 29 |
| Example 3 | | | | | | | | | | | | | | |
| Comparative | 36.09 | 2.94 | 12.30 | 0.57 | 0.00 | 0.61 | 1.97 | Balance | 1.2 | A | 389 | 90 | 18 | 14 |
| Example 4 | | | | | | | | | | | | | | |
| Comparative | 24.50 | 0.18 | 19.72 | 0.57 | 0.00 | 0.98 | 0.12 | Balance | 0.4 | A | 1210 | 49 | 81 | 4 |
| Example 5 | | | | | | | | | | | | | | |
| Comparative | 21.81 | 6.47 | 17.55 | 0.57 | 0.00 | 0.87 | 4.33 | Balance | 0.8 | A | 374 | 53 | 4 | 31 |
| Example 6 | | | | | | | | | | | | | | |
| Comparative | 24.40 | 0.25 | 19.70 | 0.57 | 0.00 | 0.98 | 0.25 | Balance | 0.3 | B | 1063 | 48 | 10 | 5 |
| Example 7 | | | | | | | | | | | | | | |
| Comparative | 17.80 | 16.09 | 14.32 | 0.57 | 0.00 | 0.71 | 3.94 | Balance | 0.7 | A | 343 | 38 | 4 | 29 |
| Example 8 | | | | | | | | | | | | | | |
| Comparative | 23.32 | 2.94 | 18.77 | 0.57 | 0.00 | 0.38 | 1.97 | Balance | 2.2 | B | 637 | 42 | 11 | 14 |
| Example 9 | | | | | | | | | | | | | | |
| Comparative | 21.56 | 2.94 | 17.35 | 0.57 | 0.00 | 6.46 | 1.97 | Balance | — | — | — | — | — | 14 |
| Example 10 | | | | | | | | | | | | | | |
| Comparative | 22.64 | 2.94 | 18.22 | 1.30 | 0.00 | 0.90 | 1.97 | Balance | — | — | — | — | — | 14 |
| Example 11 | | | | | | | | | | | | | | |

TABLE 2

| | | | | | | | | | Oxidation resistance | | | | | Volume |
|---|---|---|---|---|---|---|---|---|---|---|---|---|---|---|
| | | | | | | | | | | Presence or | | | | ratio of |
| | | | | | | | | | | absence of | | Wear resistance | | lubrication |
| Specimen | Total composition (mass %) | | | | | | | | Porosity | oxidation | Strength | Block | Roll | phase |
| No. | Cr | Mo | Ni | P | B | Si | S | Fe | (%) | scale peeling | (MPa) | (μm) | (μm) | (volume %) |
| Example 12 | 23.59 | 2.94 | 18.99 | 0.00 | 0.20 | 0.94 | 1.97 | Balance | 0.2 | A | 902 | 66 | 12 | 14 |
| Example 13 | 23.73 | 2.94 | 19.10 | 0.00 | 0.09 | 0.95 | 1.97 | Balance | 0.9 | A | 878 | 58 | 14 | 14 |
| Example 14 | 22.84 | 2.94 | 18.38 | 0.00 | 0.80 | 0.91 | 1.97 | Balance | 0.8 | A | 749 | 53 | 22 | 14 |
| Comparative | 22.77 | 2.94 | 18.32 | 0.00 | 0.86 | 0.91 | 1.97 | Balance | — | — | — | — | — | 14 |
| Example 12 | | | | | | | | | | | | | | |
| Example 15 | 23.85 | 2.94 | 19.19 | 0.00 | 0.00 | 0.95 | 1.97 | Balance | 0.4 | A | 883 | 68 | 10 | 14 |
| Example 16 | 23.09 | 2.94 | 18.58 | 0.54 | 0.20 | 0.92 | 1.97 | Balance | 0.6 | A | 694 | 53 | 14 | 14 |

TABLE 3

| | | | Oxidation resistance | | | Wear resistance | |
|---|---|---|---|---|---|---|---|
| Specimen | Solid | Added amount | Porosity | Presence or absence of | Strength | Block | Roll |
| No. | lubricant | (mass %) | (%) | oxidation scale peeling | (MPa) | (μm) | (μm) |
| Example 17 | CaF₂ | 0.10 | 0.5 | A | 1075 | 75 | 20 |
| Example 18 | CaF₂ | 1.00 | 1.8 | A | 612 | 74 | 10 |
| Comparative | CaF₂ | 1.20 | 2.6 | B | 553 | 70 | 11 |
| Example 13 | | | | | | | |
| Example 19 | Talc | 0.10 | 0.4 | A | 1138 | 73 | 18 |
| Example 20 | Talc | 1.00 | 1.9 | A | 977 | 70 | 8 |
| Comparative | Talc | 1.20 | 2.4 | B | 878 | 72 | 7 |
| Example 14 | | | | | | | |
| Example 21 | BN | 0.10 | 0.3 | A | 1160 | 74 | 20 |
| Example 22 | BN | 1.00 | 1.5 | A | 856 | 71 | 15 |
| Comparative | BN | 1.20 | 2.1 | B | 732 | 71 | 15 |
| Example 15 | | | | | | | |

Regarding sintered sliding member specimen Nos. 1 to 11 for each entire composition shown in Table 1, the porosity (%), the presence or absence of oxidation scale peeling, the radial crushing strength (MPa), the wear resistance (block (μm) and the roll (μm)) are shown.

From the results shown in Table 1, it was found that, in a case of the sintered sliding member in which the entire composition (entire composition) is a composition composed containing, by mass %, Cr: 18% to 35%, Mo: 0.3% to 15%, Ni: 0% to 30%, Si: 0.5% to 6%, S: 0.2% to 4.0%, and a Fe balance containing inevitable impurities (Examples 1 to 11), it is possible to provide the sintered sliding member having a low porosity as 0.2% to 1.8%, excellent oxidation resistance, a high strength, and excellent wear resistance.

In addition, the specimen of Examples 1 to 11 shown in Table 1 is a specimen obtained by adding the FeP as the sintering aid into the raw material mixed powder, and FeP is a specimen which blocks the pores as the liquid phase during the sintering and decreases the porosity.

The specimen of Comparative Examples 1 to 3 shown in Table 1 were sintered sliding members having a low Cr content, but peeling of the oxidation scale was observed, which caused a problem in oxidation resistance. Although the specimen of Comparative Example 4 is a specimen with a too large Cr content, the wear resistance of the test piece (sintered sliding member itself) was decreased and the strength was also decreased.

The specimen of Comparative Example 5 is a specimen having too small Mo content and S content, but the wear of the shaft (mating material) was increased. The small Mo content and S content results in a specimen having a low ratio of the lubrication phase.

The specimen of Comparative Example 6 is a specimen having too large only S content, the strength of the sintered sliding member was decreased.

The specimen of Comparative Example 7 is a specimen having too small content only for Mo, but the peeling of oxidation scale was observed, and oxidation resistance is decreased.

The specimen of Comparative Example 8 is a specimen having too small Cr content and too large Mo content, but the strength was decreased.

The specimen of Comparative Example 9 is a specimen too small Si content, but the porosity increased to be higher than 2%, and the peeling of the oxidation scale also occurred.

The specimen of Comparative Example 10 is a specimen having too large Si content, but the amount of the liquid phase during the sintering is large, which causes a problem of deformation during the sintering.

The specimen of Comparative Example 11 is a specimen having too large P content, but the amount of the liquid phase during the sintering is large, which causes a problem of deformation during the sintering.

In addition, the specimen of Examples 12 to 14 shown in Table 2 is a specimen obtained by adding the FeB as the sintering aid into the raw material mixed powder, and FeB is a specimen which blocks the pores as the liquid phase during the sintering and decreases the porosity.

The specimen of Comparative Example 12 shown in Table 2 is a specimen having too large B content, but the amount of the liquid phase during the sintering is large, which causes a problem of deformation during the sintering.

The specimen of Example 15 shown in Table 2 is a specimen by sintering as fine powder having an average particle size of 10 μm of the base powder without using the sintering aid of FeP or FeB, but it is found that a sintered sliding member having a porosity low as 0.4%, excellent oxidation resistance, a high strength, and excellent wear resistance is obtained.

The specimen of Example 16 shown in Table 2 is a specimen obtained by producing and sintering the raw material mixed powder by using both FeP powder and FeB powder as the sintering aid, but it is found that a sintered sliding member having a porosity low as 0.6%, excellent oxidation resistance, a high strength, and excellent wear resistance is obtained.

The specimen of Examples 17 to 22 shown in Table 3 is a specimen obtained by adding any of 1 mass % or less of CaF₂, talc, and BN to the components constituting the matrix and the lubrication phase in the specimen of Example 6. The specimen of Examples 17 to 22 is a specimen having a low porosity, and capable of maintaining excellent result of block for the wear resistance and obtaining more excellent roll result, while suppressing the peeling of the oxidation scale. In Examples 17 to 22, excellent results were obtained with an added amount of 0.1 to 1.0 mass %.

The specimen of Comparative Examples 13 to 15 shown in Table 3 is a specimen in which the added amount of CaF₂, talc, or BN is set to a value exceeding 1 mass %. Since the peeling of the oxidation scale occurred in all the specimen, it is desirable that the added amount of CaF₂, talc, or BN is 1 mass % or less.

FIG. 2 is an enlarged photograph of a surface structure of a specimen No. 4 shown in Table 1. As shown in this microstructure photograph, the sintered sliding member of the example exhibited a structure in which lubrication phases (CrS) in an undefined shape were dispersed in a matrix (Fe—Cr—Mo—Ni—Si phase). As a result of performing EDX analysis (energy dispersive X-ray spectrometry) on the lubrication phase shown in the microstructure photograph of FIG. 2, it was clear that it was (Cr—Mo—Fe)—S containing Cr—S as a main component.

In addition, in the structure, fine pores indicated by black circles were dispersed, although they are extremely small in size.

### INDUSTRIAL APPLICABILITY

It is possible to provide a sintered sliding member having a low porosity, having oxidation resistance, excellent wear resistance, and low mating attacking properties, and a method for producing the same.

### REFERENCE SIGNS LIST

1 bearing part (sintered sliding member)
2 matrix (Fe—Cr—Mo—Ni—Si phase)
3 lubrication phase

1. A sintered sliding member comprising:
a lubrication phase; and
a matrix, wherein
the lubrication phase is dispersed in the matrix,
an entire composition of the sliding member is composed of a composition containing, by mass %, Cr: 18% to 35%, Mo: 0.3% to 15%, Ni: 0% to 30%, Si: 0.5% to 6%, S: 0.2% to 4.0%, P: 0% to 1.2%, B: 0% to 0.8%, and a Fe balance containing inevitable impurities,
the matrix is a Fe—Cr—Mo—Si-based matrix or a Fe—Cr—Mo—Ni—Si-based matrix,
the lubrication phase contains chromium sulfide, and
a porosity of an entire sliding member is 2.0% or less.

2. The sintered sliding member according to claim 1,
wherein the lubrication phase is formed of Cr—S or (Cr—Mo—Fe)—S.

3. A sintered sliding member comprising;
a lubrication phase;
a solid lubricant; and
a matrix, wherein
the lubrication phase and the solid lubricant are dispersed in the matrix,
a composition of a main phase formed of the matrix and the lubrication phase is composed of a composition containing, by mass %, Cr: 18% to 35%, Mo: 0.3% to 15%, Ni: 0% to 30%, Si: 0.5% to 6%, S: 0.2% to 4.0%, P: 0% to 1.2%, B: 0% to 0.8%, and a Fe balance containing inevitable impurities,
the matrix is a Fe—Cr—Mo—Si-based matrix or a Fe—Cr—Mo—Ni—Si-based matrix,
the lubrication phase contains chromium sulfide,
a porosity of an entire sliding member is 2.0% or less, the solid lubricant is composed of one or two or more of CaF₂, talc, and BN, and
the lubricant is contained in an amount of 1 mass % or less with respect to the main phase.

4. A method for producing a sintered sliding member that has a structure in which a lubrication phase is dispersed in a matrix,
wherein an entire composition of the sliding member is composed containing, by mass %, a composition of Cr: 18% to 35%, Mo: 0.3% to 15%, Ni: 0% to 30%, Si: 0.5% to 6%, S: 0.2% to 4.0%, P: 0% to 1.2%, B: 0% to 0.8%, and a Fe balance containing inevitable impurities, the matrix is a Fe—Cr—Mo—Si-based matrix or a Fe—Cr—Mo—Ni—Si-based matrix, the lubrication phase contains chromium sulfide, and a porosity of an entire sliding member is 2.0% or less, the method comprising steps of:
mixing a FeCr-based or FeCrNi-based alloy powder with a MoS₂ powder to obtain a mixed powder;
press-forming the mixed powder to produce a green compact; and
sintering the green compact at 1100° C. or higher in a vacuum atmosphere.

5. A method for producing a sintered sliding member that has a structure in which a lubrication phase and a solid lubricant are dispersed in a matrix, in which a composition of a main phase formed of the matrix and the lubrication phase is composed of a composition containing, by mass %, Cr: 18% to 35%, Mo: 0.3% to 15%, Ni: 0% to 30%, Si: 0.5% to 6%, S: 0.2% to 4.0%, P: 0% to 1.2%, B: 0% to 0.8%, and a Fe balance containing inevitable impurities, the matrix is a Fe—Cr—Mo—Si-based matrix or a Fe—Cr—Mo—Ni—Si-based matrix, the lubrication phase contains chromium sulfide, a porosity of an entire sliding member is 2.0% or less, the solid lubricant is composed of one or two or more of CaF₂, talc, and BN, and the lubricant is contained in an amount of 1 mass % or less with respect to the main phase, the method comprising the steps of:
mixing a FeCr-based or FeCrNi-based alloy powder, a MoS₂ powder, and a solid lubricant powder with each other to obtain a mixed powder;
press-forming the mixed powder to produce a green compact; and
sintering the green compact at 1100° C. or higher in a vacuum atmosphere.

6. The method for producing the sintered sliding member according to claim 4,
wherein at least one of a FeP powder and a FeB powder is added and mixed with the mixed powder.

7. The method for producing the sintered sliding member according to claim 5,
wherein at least one of a FeP powder and a FeB powder is added and mixed with the mixed powder.
